(19) United States
(12) Patent Application Publication
(10) Pub. No.: US 2009/0079874 A1
(43) Pub. Date: Mar. 26, 2009

(54) DISPLAY DEVICE WITH TIME-MULTIPLEXED LED LIGHT SOURCE

(75) Inventor: Marcellinus P.C.M. Krijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,249

(22) PCT Filed: Nov. 16, 2005
(86) PCT No.: PCT/IB05/53798

§ 371 Date: May 14, 2007

(30) Foreign Application Priority Data
Nov. 22, 2004 (EP) 04105952.8

(51) Int. Cl. H04N 5/14

(52) U.S. Cl. 348/699; 348/E05.062

(57) ABSTRACT

A method and system for performing motion estimation on a video image in successive image processing steps in an image processing system is disclosed. According to an embodiment a first motion estimation scan is performed using a first motion estimator at a first image processing step in a first direction and a second motion estimation scan is performed using the first motion estimator at the first processing step in a second direction. A first motion estimation scan is performed using a second motion estimator at a second image processing step in the second direction and a second motion estimation scan is performed using the second motion estimator at the second processing step in the first direction. Latency is reduced as the second motion estimator may begin its first motion estimation scan before the second motion estimation scan of the first motion estimator ends.

This invention pertains in general to the field of video processing. More particularly the invention relates to enhancing the quality of displayed images on a video screen, e.g. a television screen, by performing a plurality of motion estimation scans without adversely increasing the latency of the motion estimation operations in a video processing system.

It is known in the television market, where motion estimation is engaged in enhancing the quality of the displayed images, that the quality of the motion estimation is of significant importance. Among other video applications, motion estimation is used as part of the two major video applications, de-interlacing and the picture up-conversion. Also, video applications that include spatio-temporal noise reduction and sharpness enhancement will also benefit from the use of motion estimation.

In the past, only one motion estimator was used for both applications meaning that de-interlacing was run on the fly, immediately followed by the picture-rate up-conversion. On the other hand, television screens of today are bigger and brighter and hence the artefacts have become more visible. In the everlasting effort to reduce the effects of artefacts, researchers have come up with more sophisticated algorithms. The new 2-D generalised sampling theorem (GST) based de-interlacing algorithm disclosed in “A two dimensional generalised sampling theory and application to de-interlacing” by C. Ciuhu and G. de Haan, SPIE, Proceedings of VCIP, January 2004, pp 700-711, and halo-reduced picture-rate up-conversion algorithm disclosed in “Tackling occlusion in scan rate conversion systems” by R. B. Wittebrood, G. de Haan and R. Lodder, Digest of the ICCE'03, June 2003, pp. 344-45, are typical examples. These algorithms provide better end results based on the existing motion vector field, meaning that they only consume already available motion vector fields. Hence they are highly dependent on the quality of the consumed motion vector field.

One of the ways to improve the quality of the motion vector field is by increasing the number of motion estimation scans per input image pair. The greater number of scans should imply better image quality. Changing the direction of the scanning in two successive motion estimation passes, for example, the first pass is from the top to the bottom of the screen and the second pass is from the bottom of the screen to the top, seems an interesting option as well, since it enables the convergence of a motion vector field from two different directions. The effects of multiple scans, alternation of the scanning direction and two styles of scanning (meandering style, and classical style, from top to bottom and left to right) were experimentally analysed in “Towards an efficient high quality picture rate up-converter” by A. Beric, G de Haan, J. van Meerbergen and R Sethuraman, Proceedings of the IEEE International Conference on Image Processing, September 2003, on CD, which is incorporated herein by reference.

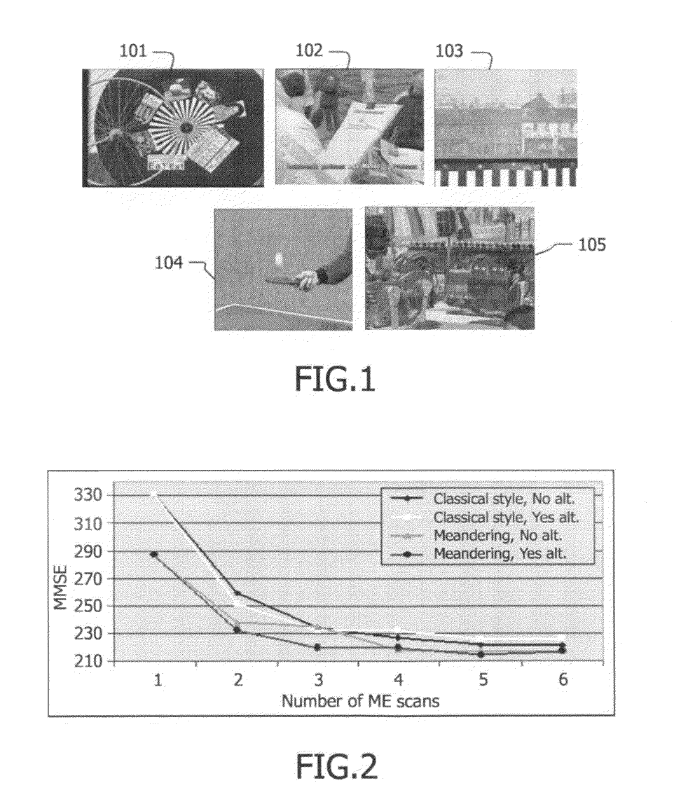

The experiment was conducted on five progressive sequences (Bicycle 101, Subtext 102, BBCdrumtext 103, Tennis 104, and Shaker 105), as illustrated in FIG. 1, using a set of six motion vector candidates. The quality of the calculated motion vector field was measured by means of Modified Mean Square Error (MMSE), the criterion widely used in the literature. Conclusions of the experiment were that increasing the number of motion estimation scans enables better quality of the motion vector field. However, after the second or third scan, the MMSE curve saturates, and more scans do not imply significantly better image quality. Also, alternation of the scanning direction helps in faster convergence of the motion vector field, especially in the case of different sequences. These conclusions are illustrated in FIG. 2, which shows the MMSE of the sequence Shaker 105 plotted for different number of motion estimation passes and with different combinations of usage of alternation and meandering style of scanning.

However, more motion estimation scans implies higher latency of the video processing system which can cause, for example, lip synchronisation loss in the case when a separate sound rendering system is used, and additional memory resources for buffering the images.

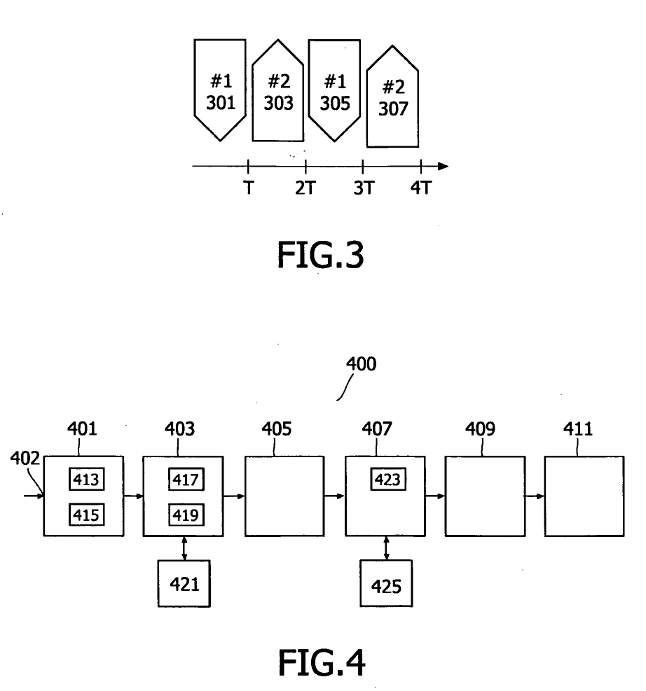

In order to maintain the high level of quality of the motion vector field, two alternating direction scans should be performed at both the de-interlacing side and the up-converter side. FIG. 3 illustrates the motion estimation scans performed at the de-interlacing side 301 and 303 and the up-conversion side 305 and 307. A single motion estimator performs the four scans. The first scan is from top to bottom and the second scan is from bottom to top. As illustrated in FIG. 3, the time needed to perform this action is 4T, given that the time needed to perform one scan is 1T. As the second scan is performed, the production of the de-interlaced frame can begin. This happens at about t=1T. The production of the up-converted frame begins at about t=3T. Unfortunately, this method produces too much undesired latency in the video processing system.

In the known method illustrated in FIG. 3, the last up-conversion motion estimation scan is performed from bottom to top. This is very inconvenient since the pixels should be displayed to a display device from top to bottom. To overcome this inconvenience, the up-converter should perform only one downward scan, which would impair the quality, or 3 scans, namely downwards, upwards, downwards (which would increase the latency and the required buffering capacity). Thus, there is a need for a new method for performing multiple motion estimation scans without unduly increasing the latency of the video image processing system.

Hence, an improved method and system for performing multiple motion estimation scans without unduly increasing the latency of the video processing system would be advantageous.

Accordingly, the present invention preferably seeks to mitigate, alleviate or eliminate one or more of the above-identified deficiencies in the art and disadvantages singly or in any combination and solves at least the above mentioned problems by providing a system, a method and a computer-readable medium that allows a video image processing system to perform multiple motion estimation scans at the de-interlacing side and the up-converter side without unduly increasing the latency of the video processing system, according to the appended patent claims.

The general solution according to the invention is to use separate motion estimators at the de-interlacing side and the up-converter side, and more particularly to change the direction of the first up-converter scan so that it can begin while the second de-interlacing scan is being performed, thereby reducing the latency of the video image processing system.

According to one aspect of the invention, a method is provided for performing motion estimation on a video image frame in successive image processing steps in an image processing system, said method comprising the steps of: performing a first motion estimation scan at a first image processing step in a first direction; performing a second motion estimation scan at the first processing step in a second direction; performing a first motion estimation scan at a second image processing step in the second direction; and performing a second motion estimation scan at the second processing step in the first direction.

According to another aspect of the invention, a system is provided processing an image frame, said system comprising: a first image processor for processing the image frame; a first motion estimator connected to the first image processor, wherein the first motion estimator first scans the frame in a first direction and then scans the frame in a second direction; a second image processor connected to an output of the first image processor for processing the frame; and a second motion estimator connected to the second image processor, wherein the second motion estimator first scans the frame in the second direction and then scans the frame in the first direction, said means being operatively connected to each other.

According to a further aspect of the invention, a computer-readable medium having embodied thereon a computer program for processing by a computer is provided. The computer program comprises a code segment for performing motion estimation on a video image frame in successive image processing steps in an image processing system, said method comprising the steps of: performing a first motion estimation scan at a first image processing step in a first direction; performing a second motion estimation scan at the first processing step in a second direction; performing a first motion estimation scan at a second image processing step in the second direction; and performing a second motion estimation scan at the second processing step in the first direction.

The present invention has the advantage over the prior art that it lowers the overall system latency and required frame buffer memory capacity without impairing the quality of the resulting signal.

These and other aspects, features and advantages of which the invention is capable of will be apparent and elucidated from the following description of embodiments of the present invention, reference being made to the accompanying drawings, in which

FIG. 1 illustrates a series of sequences used in evaluating the quality of the motion vector field;

FIG. 2 illustrates the MMSE of the Shaker sequence plotted for different number of motion estimation passes;

FIG. 3 illustrates motion estimation scans performed at the de-interlacing side and the up-converter side according to a known method;

FIG. 4 illustrates some components of a video processing system according to one embodiment of the invention;

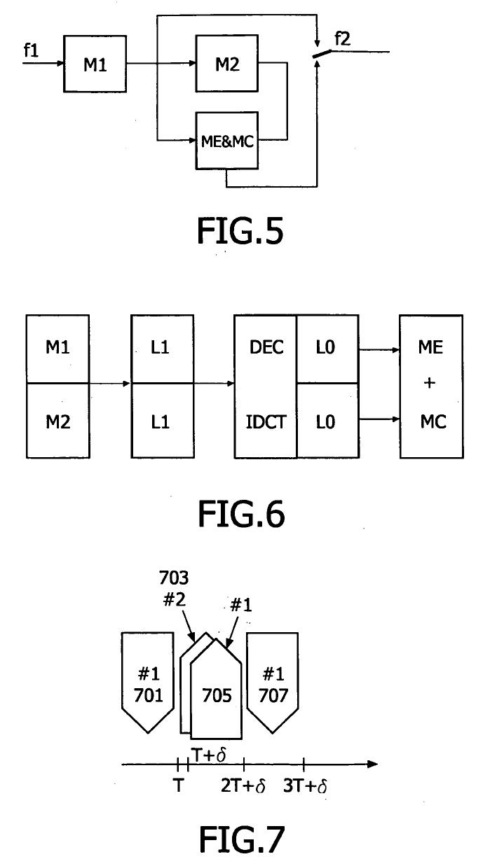

FIG. 5 illustrates a block diagram of an up-converter according to one embodiment of the invention;

FIG. 6 illustrates a block diagram of a two-level caching strategy for use in the invention; and

FIG. 7 illustrates motion estimation scans performed at the de-interlacing side and the up-converter side according to one embodiment of the invention.

The following description focuses on an embodiment of the present invention applicable to a video image processing system and in particular to a video image processing system which employs multiple motion estimations for both de-interlacing and up-conversion. However, it will be appreciated that the invention is not limited to this application but may be applied to many other video applications such as spatio-temporal noise reduction and sharpness enhancement both of which may benefit from the use of a motion estimator.

An embodiment of the invention is illustrated in FIG. 4, which is a block diagram of an image processing system 400 comprised of a plurality of stages. An image signal 402 is supplied to a first stage 401 which comprises a video decoder 413 and a spatial noise reduction unit 415 which decodes the signal into frames which are stored in a frame buffer (not shown). A frame is then selected for processing by a second stage 403 comprising a de-interlacing processor 417 and a spatio-temporal noise reduction unit 419. A motion estimator 421 is operatively connected to the de-interlacing processor 417 to perform motion estimation scans on each frame being processed by the de-interlacing processor 417 as will be described in greater detail below. An output of the de-interlacing processor is connected to the third stage 405 which comprises a spatial scaling and sharpness enhancement unit. The third stage 405 scales and sharpens the frames before they are sent to a fourth stage 407. The fourth stage 407 comprises an up-converting process 423 for up-converting frames of the image signal. A motion estimator 425 is operatively connected to the up-converting processor 423 to perform motion estimation scans on each frame being processed by the up-converting processor 423 as will be described in greater detail below. According to one embodiment of the invention, each motion estimator 421, 425 performs at least two scans per frame. The output of the up-converting processor can then be sent to a scaler 409 which adapts the frames to the proper display resolution before being sent to a display device 411.

FIG. 5 illustrates an up-conversion module which may be used in the present invention. Frame memories M1 and M2 are used for frequency conversion from picture input rate f1 to the output rate f2 and for providing the delayed image, respectively.

FIG. 6 illustrates a two level caching strategy for use by the up-converting processor 407. The data stored in the frame memories M1 and M2 as well as in the L1 cache are in the compressed form while the data stored in the L0 caches are in the uncompressed form. Data decompression block (DEC/IDCT) performs operations of decoding and finding the inverse discrete cosine transform of the stream of data. Two frames of data are needed to perform the temporal up-conversion. The level 1 (L1) cache holds five block lines, the height of the search area, of the image while the whole search area is stored in level 0 (L0) cache. The data traffic between frame memories M1 and M2 and the motion estimator/compensator (MEIMC) is minimal when the data decompression block (DEC/IDCT) takes place closer to the L0 cache.

In a first embodiment of the invention, a total of four scans are performed in the directions illustrated in FIG. 3. In this embodiment, the two motion estimators 421, 425 wherein the first motion estimator performs two scans for the de-interlacing stage and the second motion estimator performs two scans for the up-converter stage.

According to another embodiment of the invention, the operation of the image processing system 400 will now be described in more detail with reference to FIG. 7. FIG. 7 illustrates motion estimation scans performed at the de-interlacing processor 403 and the up-converting processor 407 according to one embodiment of the invention. In this embodiment of the invention, two motion estimation scans are performed in opposite directions for each motion estimator. First, the motion estimator 405 performs a motion estimation scan on a selected frame in a first direction as indicated by arrow 701. The motion estimator then performs a second scan in the other direction as illustrated by arrow 703. In accordance with the invention, once the second scan by the motion estimator 405 begins, a first motion estimation scan by the second motion estimator 409 (for the up-conversion process) begins in the opposite direction from the first scan performed by the motion estimator 405 as indicated by the arrow 705. Thus, the first up-conversion motion estimator begins before the second de-interlacing motion estimation ends. Finally, the second motion estimator 409 performs a second scan in the opposite direction from the first scan as indicated by the arrow 707. In this embodiment of the invention, the first de-interlacing motion estimation scan is from top to bottom and the second de-interlacing motion estimation scan is from bottom to top. In addition, the first up-conversion motion estimation scan is from bottom to top and the second up-conversion motion estimation scan is from top to bottom.

As in the known system illustrated by FIG. 3, as the second de-interlacing scan is proceeding, the production of the de-interlaced frame starts at about t=1T. However, as illustrated in FIG. 7, the first up-conversion motion estimation scan can begin a short time period (δ) after the beginning of the second de-interlacing scan by reversing the direction of the first up-conversion motion estimation scan. The time δ depends on the vertical dimension (the height) of the estimator's search window or search area. Typically, the height of the search area is 5 blocks (1 block defined as the region of 8*8 pixels). For standards definition (SD) resolution, the height of the frame is 72 blocks. Hence, δ=5/72T≈7% T. Thus, the latency of the image processing system which employs two motion estimation scans in different directions for both de-interlacing and up-conversion is decreased by 93%/T without diminishing the quality of the final signal.

The invention has several additional beneficial effects on the image processing system. First, the capacity of the buffer memory (frame memory) needed for up-conversion is reduced by approximately 1 frame memory (720*576*2 bytes/pixel=6.3 Mbit). Furthermore, the second up-conversion motion estimation scan is generated from top to bottom. As a result, the pixels which belong to the up-converted frame are generated from top to bottom. Due to this fact, those pixels can be immediately displayed on the display device 411.

As described above, the invention, which reverses the direction of the first motion estimation scan of the up-converter, has many advantages over other known systems without impairing the quality of the signals produced. First, the overall system latency is lower while the required frame (buffer) memory capacity is reduced. In addition, the last motion estimation scan and the up converted frame is generated from top to bottom, which means that the generated pixels can be immediately displayed on a screen.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different image processing steps than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for performing motion estimation on a video image in successive image processing steps in an image processing system, the method comprising:
performing, in a first motion estimation scan at a first image processing step, a first scanning action in a first scanning direction;
performing, in a second motion estimation scan at the first image processing step, the first scanning action in a second scanning direction;
performing, in a first motion estimation scan at a second image processing step, a second scanning action in a first scanning direction; and
performing, in a second motion estimation scan at the second image processing step, the second scanning action in a second scanning direction.

2. The method according to claim 1, the first scanning direction in the first scanning action at the first image processing step being opposite to the first scanning direction in the first scanning action at the second image processing step, and
the second scanning direction in the first scanning action at the first image processing step being opposite to the second scanning direction in the second scanning action at the second image processing step.

3. The method according to claim 1, the first scanning direction in the first scanning action at first image processing step being the same scanning direction as the first scanning direction in the second scanning action at the second image processing step, and
the second scanning direction in the first scanning action at first image processing step being the same scanning direction as the second scanning direction in the second scanning action at the second image processing step, and
the first image processing step using a first motion estimator and the second image processing step using a second motion estimator.

4. The method according to claim 1, the first scanning direction in the first scanning action at the first image processing step being from top to bottom of the image and the second scanning direction in the first scanning action at the first image processing step being from bottom to top of the image, and
the first scanning direction in the second scanning action at the second image processing step being from bottom to top of the image and the second scanning direction in the second scanning action at the second image processing step being from top to bottom of the image.

5. The method according to claim 1, wherein the first image processing step corresponds to de-interlacing.

6. The method according to claims 1 or 5, wherein the second processing step corresponds to up-conversion.

7. The method according to claim 1, wherein the motion estimation scans for the first image processing step being performed by a first motion estimator and the motion estimation scans for the second image processing step being performed by a second motion estimator.

8. The method according to claim 1, the first motion estimation scan at the second image processing step beginning before ending the second motion estimation scan of the first image processing step.

9. An image processing system for processing an image, the system comprising:
a first image processor (417) for processing the image;
a first motion estimator (421) connected to the first image processor (417), wherein the first motion estimator (421) is configured to first scan the image in a first scanning direction and then to scan the image in a second scanning direction;
a second image processor (423) connected to an output of the first image processor (417) for processing the image;
a second motion estimator (425) connected to the second image processor (423), wherein the second motion estimator (425) is configured to consecutively scan the image in two different scanning directions, wherein the image processors (417, 423) and motion estimators (421, 425) are operatively connected to each other.

10. The system according to claim 9, wherein the second motion estimator (425) is configured to first scan the image in the first scanning direction and then to scan the image in the second scanning direction.

11. The system according to claim 9, wherein the second motion estimator (425) is configured to first scan the image in the second scanning direction and then to scan the image in the first scanning direction.

12. The system according to claim 9 or 11, wherein said first scanning direction is from top to bottom of the image and the second scanning direction is from bottom to top of the image.

13. The system according to claim 9, wherein the first image processor (417) is configured to perform de-interlacing.

14. The system according to claim 9 or 13, wherein the second image processor (423) is configured to perform up-conversion.

15. The system according to claim 9, wherein the second motion estimator (425) is configured to begin its first motion estimation scan before the second motion estimation scan of the first motion estimator (421) ends.

16. A computer-readable medium having embodied thereon a computer program for performing motion estimation on a video image in successive image processing steps in an image processing system, for processing by a computer, the computer program comprising code segments for:
performing, in a first motion estimation scan at a first image processing step, a first scanning action in a first scanning direction;
performing, in a second motion estimation scan at the first image processing step, the first scanning action in a second scanning direction;
performing, in a first motion estimation scan at a second image processing step, a second scanning action in a first scanning direction; and
performing, in a second motion estimation scan at the second image processing step, the second scanning action in a second scanning direction.
